(19) United States
(12) Patent Application Publication
(10) Pub. No.: US 2014/0133597 A1
(43) Pub. Date: May 15, 2014

(54) METHOD FOR TRANSMITTING AND RECEIVING DATA IN OFDM SYSTEM AND APPARATUS THEREOF

(71) Applicant: ELECTRONICS AND TELECOMMUNICATIONS RESEARCH INSTITUTE, Daejeon (KR)

(72) Inventors: Young Kwon HAHM, Daejeon (KR); Dong Joon CHOI, Daejeon (KR); Nam Ho HUR, Daejeon (KR)

(73) Assignee: Electronics and Telecommunications Research Institute, Daejeon (KR)

(21) Appl. No.: 13/779,933

(22) Filed: Feb. 28, 2013

(30) Foreign Application Priority Data
Nov. 12, 2012 (KR) 10-2012-0127226

(51) Int. Cl. H04L 27/26

(52) U.S. Cl. CPC H04L 27/2602
USPC 375/295; 375/340

(57) ABSTRACT

Disclosed are a method for transmitting and receiving data and an apparatus thereof, and more particularly, a method for transmitting and receiving data and an apparatus thereof in an orthogonal frequency division multiplexing (OFDM) system. The method for transmitting data in an OFDM system according to the present invention includes encoding and modulating data to be transmitted, configuring the modulated data by a frame constituted by N (an integer larger than 0) OFDM symbols, and transmitting the configured frame, in which the frame includes a first OFDM symbol including a pilot symbol and a second OFDM symbol including lower-order modulated than the modulated data.

### CROSS-REFERENCE TO RELATED APPLICATIONS

This application claims priority to and the benefit of Korean Patent Application No. 10-2012-0127226 filed in the Korean Intellectual Property Office on Nov. 12, 2012, the entire contents of which are incorporated herein by reference.

### TECHNICAL FIELD

The present invention relates to a method for transmitting and receiving data and an apparatus thereof, and more particularly, to a method for transmitting and receiving data and an apparatus thereof in an orthogonal frequency division multiplexing (OFDM) system.

BACKGROUND ART

OFDM, which divides a data stream having high transmission rate into a lot of data streams having low transmission rate and transmits the data streams simultaneously by using a plurality of subcarriers, is a special type of a multiple subcarrier transmission scheme for transmitting the data streams through several sub-channels in line simultaneously. The OFDM technique is a multiplexing technique in terms of transmitting high-speed original data streams of one channel through multiple channels simultaneously, and may correspond to a kind of modulation technique in terms of transmitting the data streams which are divided into and loaded on multiple subcarriers. A waveform of each subcarrier is orthogonal on a time axis, but overlaps on a frequency axis.

The OFDM as a band spread technique spreads data to a lot of carriers spaced apart from an accurate frequency by a predetermined distance. The distance provides orthogonality to prevent a demodulator from referring to a frequency other than its own frequency. Therefore, the OFDM is resistant to frequency selective fading or narrow-band interference. In a single carrier system, all links may fail by one fade or interference, but in a multi-carrier system, only some subcarriers are influenced.

Meanwhile, in association with a cable network, as a downward physical layer transmission scheme which is being used on the cable network at present, a single carrier scheme is used, and in the case of DVB-C2 which is a transmission standard standardized as a next cable network transmission scheme, the OFDM which is a multi-carrier scheme is adopted.

As described above, the OFDM scheme can easily compensate for signal distortion due to a multi-reflection wave of a channel, and is frequently used in high-speed signal transmission due to a lot of merits such as easy application of a multiple-input multiple-output (MIMO) antenna technology, and like. However, like the transmission standard such as the DVB-C2, a system delay is large in signal transmission, and as a result, the OFDM scheme may be inappropriate in interactive services in which a real time feature is important, such as a network game, crowd computing, and the like. In order to overcome the problem, even significantly reducing the size of a window of FFT may be one method, but in this case, a pilot insertion cycle for estimating channel distortion becomes shorter and overhead by pilot insertion may be significantly larger, thereby deteriorating frequency use efficiency of a system.

### SUMMARY OF THE INVENTION

The present invention has been made in an effort to provide a method for transmitting data and an apparatus thereof in an OFDM system that can reduce a system delay while improving frequency use efficiency.

An exemplary embodiment of the present invention provides a method for transmitting data in an OFDM system, including: encoding and modulating data to be transmitted, configuring the modulated data by a frame constituted by N (an integer larger than 0) OFDM symbols, and transmitting the configured frame, in which the frame includes a first OFDM symbol including a pilot symbol and a second OFDM symbol including lower-order modulated than the modulated data.

Another exemplary embodiment of the present invention provides an apparatus for transmitting data in an OFDM system, including: a modulation unit encoding and modulating data to be transmitted, a frame configuration unit configuring the modulated data by a frame constituted by N (an integer larger than 0) OFDM symbols, and a transmitting unit transmitting the configured frame, in which the frame includes a first OFDM symbol including a pilot symbol and a second OFDM symbol including lower-order modulated than the modulated data.

Yet another exemplary embodiment of the present invention provides a method for receiving data in an OFDM system, including: receiving a frame a first OFDM symbol including a pilot symbol and a second OFDM symbol including a lower-order modulated symbol than modulated data, in which modulated data is constituted by N (an integer larger than 0) OFDM symbols, a first estimation step of performing channel distortion estimation by using the first OFDM symbol including the pilot symbol in the frame, and a second estimation step of performing channel distortion estimation by using the second OFDM symbol including an estimation value of the first estimation step and the lower-order modulated than the modulated data.

Still another exemplary embodiment of the present invention provides an apparatus for receiving data in an OFDM system, including: a receiving unit receiving a frame including a first OFDM symbol including a pilot symbol and a second OFDM symbol including a lower-order modulated symbol than modulated data, in which the modulated data is constituted by N (an integer larger than 0) OFDM symbols, and a channel distortion estimating unit performing first channel distortion estimation by using the first OFDM symbol including the pilot symbol in the frame and performing second channel distortion estimation by using an estimation value of the first channel distortion estimation and the second OFDM symbol including the lower-order modulated symbol than the modulated data.

According to exemplary embodiments of the present invention, frequency use efficiency can be improved. In another exemplary embodiment, a system delay can be reduced at the same time.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram for describing a method for transmitting data in an OFDM system according to an exemplary embodiment of the present invention.

FIG. 2 is a diagram for describing an apparatus for transmitting data in an OFDM system according to an exemplary embodiment of the present invention.

FIG. 3 is a diagram for describing a method for receiving data in an OFDM system according to an exemplary embodiment of the present invention.

FIG. 4 is a diagram for describing an apparatus for receiving data in an OFDM system according to an exemplary embodiment of the present invention.

FIG. 5 is a diagram for describing a detailed exemplary embodiment of a configuration of a transmission system including a transmitting unit and a receiving unit.

FIG. 6 is a diagram for describing an example of a signal frame generated in a frame configuration unit in the transmission system illustrated in FIG. 5.

FIG. 7 is a procedure diagram for describing a channel distortion estimating process described in the detailed exemplary embodiment of FIGS. 5 and 6 in detail.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

The following content just exemplifies the principle of the present invention. Therefore, those skilled in the art can implement the principle of the present invention and invent various apparatuses included in a concept and a scope of the present invention. All conditional terms and exemplary embodiments enumerated in this specification are apparently used to understand the concept of the present invention in principle and it should be understood that all of the conditional terms and exemplary embodiments are not limited to particular enumerated exemplary embodiments and states as described above.

It should be understood that all detailed descriptions of specifying a specific exemplary embodiment as well as a principle, a viewpoint, and exemplary embodiments of the present invention are intended to include structural and functional equivalents of the points. It should be understood that the equivalents are intended to include equivalents to be developed in the future, that is, all elements invented to perform the same function regardless of the structure as well as equivalents which are known at present.

Therefore, for example, it should be understood that a block diagram of this specification illustrates an exemplary conceptual viewpoint to implement the principle of the present invention. Similarly, it should be understood that all flowcharts, state conversion diagrams, Pseudo codes, and the like can be substantially illustrated in computer-readable media and illustrate various processes performed by a computer or a processor regardless of whether the computer or the processor is apparently illustrated.

Functions of various elements illustrated in a drawing including the processor or a functional block displayed as a concept similar thereto can be provided by using hardware having an ability to execute software in association with appropriate software as well as exclusive hardware. When the functions are provided by the processor, the functions can be provided by a single exclusive processor, a single share processor, or a plurality of individual processors and some thereof can be shared.

The apparent use of the processor, a control or a term presented as a concept similar thereto should not be analyzed by exclusively citing hardware having an ability to execute software and it should be understood that the processor, the control or the term presented as the concept similar thereto implicitly include digital signal processor (DSP) hardware, and a ROM, a RAM, and a nonvolatile memory for storing software without a limit. Well-known other hardware may be included.

In the appended claims of this specification, components expressed as means for performing functions disclosed in a detailed description are intended to include, for example, combinations of circuit elements that perform the functions or all methods of performing functions all formats of software including firmware, a micro code, and the like and are coupled with an appropriate circuit for execute the software so as to perform the functions. In the invention defined by the appended claims, since functions provided by various enumerated means are coupled with each other and coupled with a scheme which the claims request, it should be understood that all means capable of providing the functions is equivalent to those grasped from this specification.

The aforementioned objects, features, and advantages will be more apparent through the following detailed description associated with the accompanying drawings, and as a result, the spirit of the present invention can be easily implemented by those skilled in the art. It is judged that a detailed description of a known art associated with the present invention may make the gist of the present invention be obscure, the detailed description thereof will be omitted. Hereinafter, exemplary embodiments of the present invention will be described in detail with reference to the accompanying drawings.

A method for transmitting and receiving data and an apparatus thereof in an OFDM system disclosed in this specification can more accurately perform channel distortion estimation by configuring a transmission signal frame of the OFDM system, improve frequency use efficiency, and reduce a system delay.

A transmission side transmits a frame constituted by N (N is an integer larger than 0) OFDM symbols, which includes a first OFDM symbol including a pilot symbol a second OFDM symbol including a lower-order modulated symbol than a modulation scheme applied to transmission data. All of N−1 OFDM symbols other than the first OFDM symbol including the pilot symbol may include the low-order modulated symbol.

Meanwhile, a reception side performs channel distortion estimation of the first OFDM symbol including the pilot symbol by using the pilot symbol in the received frame, and performs additional channel distortion estimation by using the channel distortion estimation value processed in the first OFDM symbol and the second OFDM symbol including the low-order modulated symbol. In the additional channel distortion estimation, a plurality of channel distortion estimations is performed in one frame, and as a result, channel distortion estimation may be stably performed. When the low-order modulated symbol is included in all of N−1 OFDM symbols other than the first OFDM symbol including the pilot symbol, N channel distortion estimations are performed in one frame, and channel distortion estimation for a current OFDM symbol is performed by using a channel distortion estimation value for a previous OFDM symbol and the low-order modulated symbol included in the current OFDM symbol.

Hereinafter, technical features disclosed in this specification will be described in detail with reference to the accompanying drawings. Therefore, an already well known process or functioning unit in methods and apparatuses to be described below will not be described. However, the already well known process or functioning unit in the methods and apparatuses to be described below may be additionally included in methods and apparatuses disclosed in this specification.

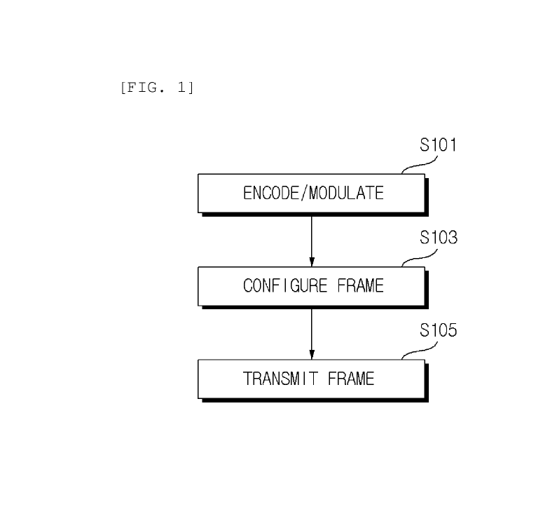

FIG. 1 is a diagram for describing a method for transmitting data in an OFDM system according to an exemplary embodiment of the present invention.

Referring to FIG. 1, a method for transmitting data in an OFDM system includes encoding and modulating data to be transmitted (S101), configuring the modulated data by a frame constituted by N (an integer larger than 0) OFDM symbols (S103), and transmitting the configured frame (S105), and the frame includes a first OFDM symbol including a pilot symbol and a second OFDM symbol including lower-order modulated symbol than the modulated data. Herein, the OFDM symbol is a concept distinguished from the pilot symbol, the low-order modulated symbol, and a data symbol to be described below, and the pilot symbol, the low-order modulated symbol, and the data symbol constitute the OFDM symbol.

The frame may include subframes, and in this case, the subframes may include the OFDM symbol. The pilot symbol is a concept distinguished from the data symbol, and the data symbol means a symbol including predetermined information.

The low-order modulated symbol means a symbol modulated in a lower-order modulation scheme than a modulation scheme for data to be transmitted. For example, in the case where the modulation scheme of the data to be transmitted is 1024 QAM, the low-order modulated symbol is a symbol modulated in a 16 QAM or QAM scheme which is lower modulation schemes than 1024 QAM.

When another OFDM symbol constituting the frame other than the pilot symbol generally included in the frame, which include the low-order modulated symbol, is transmitted, channel distortion estimation may be performed by using the low-order modulated symbol other than the pilot symbol in a receiver. Accordingly, a plurality of channel distortion estimations may be performed in one frame, and as a result, the channel distortion estimation may be stably performed.

The low-order modulated symbol may be the pilot symbol. That is, as a case in which the pilot symbols are included in different OFDM symbols constituting one frame, in the case where a channel state is not good, the channel distortion estimation may be accurately performed in the receiver.

Meanwhile, the low-order modulated symbol may be the data symbol. The data symbol is a symbol including information, and in the case where the modulated data is modulated to 1024 QAM, the low-order modulated data symbol is modulated to 16 QAM or QAM. As compared with the case where the low-order modulated symbol is the pilot symbol, the low-order modulated data is positioned in a section where a pilot will be placed in the case where the low-order modulated symbol is the data symbol, and as a result, the frequency use efficiency may be improved. The data symbol may include user information or physical layer service configuration information. When the data symbol includes not general data but the user information or the physical layer service configuration information, a power saving effect may be improved and a system delay may be reduced because a control signal is not additionally configured.

In the configuration of the frame, the pilot symbol is included in a first OFDM symbol constituting the frame, and the remaining OFDM symbols may include the respective low-order modulated symbols. In this case, the channel distortion estimation may be performed with respect to all of the OFDM symbols constituting the frame by using the pilot symbol and the low-order modulated symbol, respectively. The stability in the channel distortion estimation may be further improved. As described above, in the case where a channel estimation result for a previous OFDM symbol is used for channel estimation for a current OFDM symbol, the channel distortion estimation may be most effectively performed.

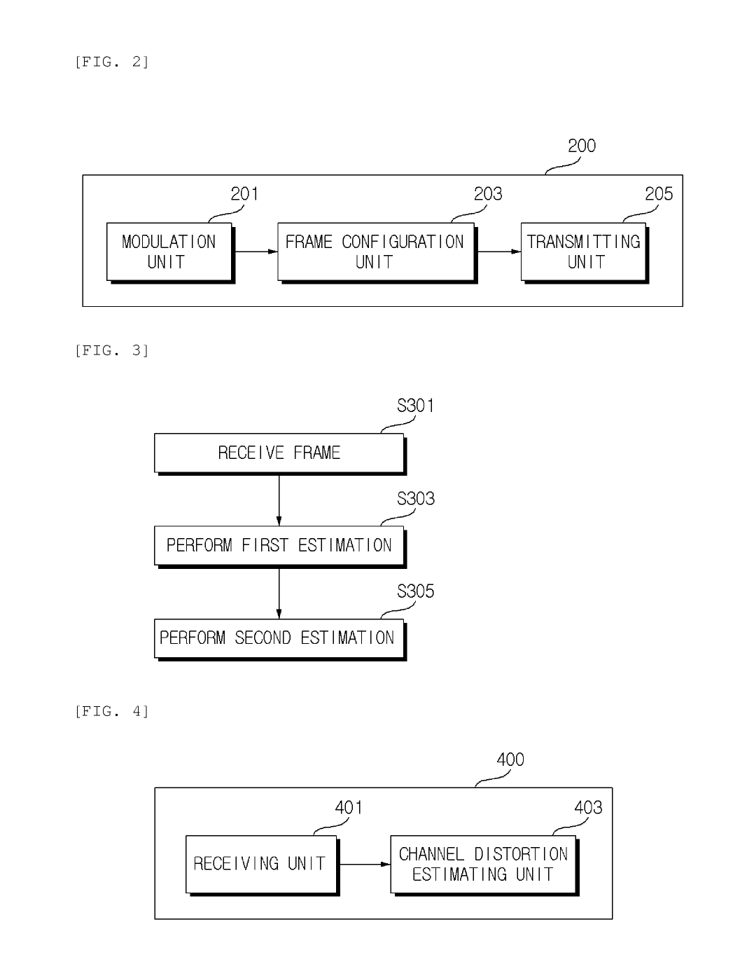

FIG. 2 is a diagram for describing an apparatus for transmitting data in an OFDM system according to another exemplary embodiment of the present invention.

Referring to FIG. 2, an apparatus 200 for transmitting data in an OFDM system includes a modulation unit 201 encoding and modulating data to be transmitted, a frame configuration unit 203 configuring the modulated data by a frame constituted by N (an integer larger than 0) OFDM symbols, and a transmitting unit 205 transmitting the configured frame, and the frame includes a first OFDM symbol including a pilot symbol and a second OFDM symbol including lower-order modulated symbol than the modulated data. Herein, the low-order modulated symbol may be a pilot symbol or a data symbol. The data symbol may include user information or physical layer service configuration information. Meanwhile, in the configuration of the frame, the first OFDM symbol is a first OFDM symbol constituting the frame, and the second OFDM symbol may be all of the remaining OFDM symbols.

The apparatus for transmitting data in the OFDM system described in FIG. 2 is achieved by implementing the method for transmitting data in the OFDM system described in FIG. 1 as an apparatus, and a duplicated description will be omitted.

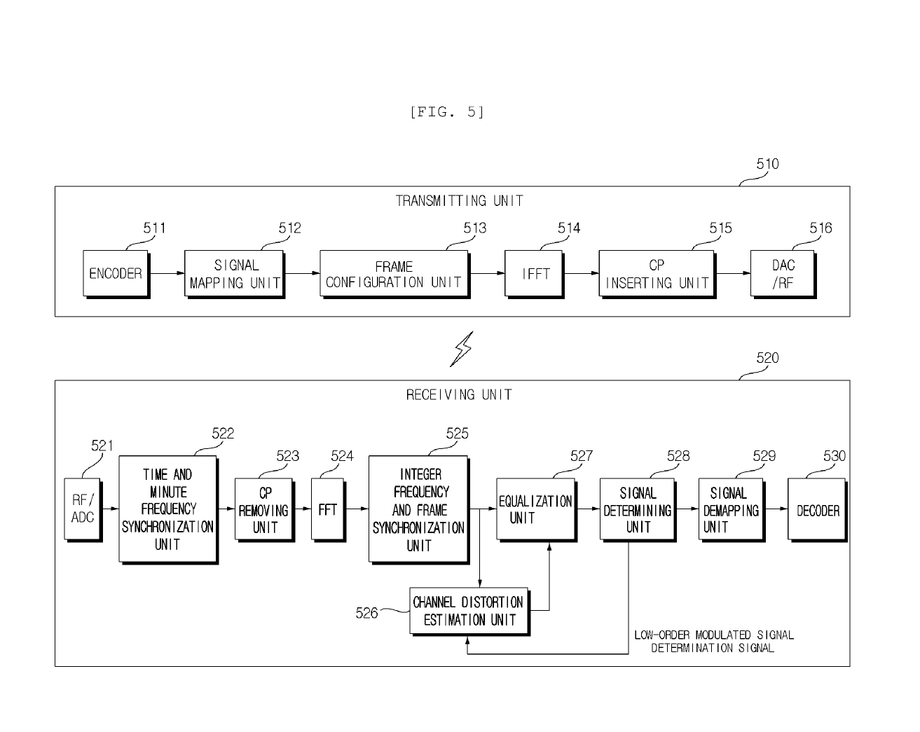

FIG. 3 is a diagram for describing a method for receiving data in an OFDM system according to the present invention.

Referring to FIG. 3, the method for receiving data in an OFDM system includes receiving a frame including a first OFDM symbol including a pilot symbol while modulated data is constituted by N (an integer larger than 0) OFDM symbols and a second OFDM symbol including a lower-order modulated symbol than the modulated data (S301), a first estimation step of performing channel distortion estimation by using the first OFDM symbol including the pilot symbol in the frame (S303), and a second estimation step of performing channel distortion estimation by using an estimation value of the first estimation step and the second OFDM symbol including a lower-order modulated symbol than the modulated data (S305). That is, a plurality of channel estimations is performed in one frame, and herein, the channel estimation is performed by using a channel estimation value for a previous OFDM symbol and the low-order modulated symbol included in the current OFDM symbol.

Herein, the low-order modulated symbol may include the pilot symbol. Alternatively, the low-order modulated symbol may include the data symbol. In the case where the low-order modulated symbol is the data symbol, the data symbol may include user information or physical layer service configuration information.

Meanwhile, the frame is constituted by the first OFDM symbol including the pilot symbol and the remaining N−1 OFDM symbols including the respective low-order modulated symbols of the frame, and in this case, the second estimation process (S303) of the method for receiving data may further include a consecutive estimation step of performing the channel distortion estimation by using a channel distortion estimation value using an n-th OFDM symbol (an integer of 1<n<N) and the low-order modulated symbol included in an n+1-th OFDM symbol and a repetition process of repeating the consecutive estimation step up to an N-th OFDM symbol. That is, the channel distortion estimation is performed with respect to all of the OFDM symbols included in the frame, and the channel distortion estimation for each OFDM symbol is performed by using a channel distortion estimation value of a previous OFDM symbol with respect to all OFDM symbols other than the first OFDM symbol and the low-order modulated of the current OFDM symbol. The method for receiving data in the OFDM system of

FIG. 3 is described at a receiving side corresponding to the method for transmitting data in the OFDM system of FIG. 1, and a duplicated description will be omitted.

FIG. 4 is a diagram for describing an apparatus for receiving data in an OFDM system according to the exemplary embodiment of the present invention.

Referring to FIG. 4, an apparatus 400 for receiving data in an OFDM system includes a receiving unit 401 receiving a frame including a first OFDM symbol including a pilot symbol and a second OFDM symbol including a lower-order modulated symbol than the modulated data which is constituted by N (an integer larger than 0) OFDM symbols, and a channel distortion estimating unit 403 performing first channel distortion estimation by using the first OFDM symbol including the pilot symbol in the frame and performing second channel distortion estimation by using an estimation value of the first channel distortion estimation and the second OFDM symbol including a lower-order modulated symbol than the modulated data. Herein, the low-order modulated symbol may include the pilot symbol. Alternatively, the low-order modulated symbol may include the data symbol. Herein, in the case where the low-order modulated symbol is the data symbol, the data symbol may include user information or physical layer service configuration information.

Meanwhile, the frame is constituted by the first OFDM symbol of the frame including the pilot symbol and the remaining N−1 OFDM symbols including the respective low-order modulated symbols, and the channel distortion estimating unit 403 performs channel distortion estimation for the second OFDM symbol by using the estimation value of the channel distortion estimation for the first OFDM symbol and the low-order modulated symbol included in the second OFDM symbol of the frame, and performs channel distortion estimation for an n+1-th OFDM symbol by using a channel distortion estimation value using an n-th OFDM symbol (an integer of 1<n<N) and the low-order modulated symbol included in the n+1-th OFDM symbol to repeat channel distortion estimation up to an N-th OFDM symbol.

The apparatus for receiving data in the OFDM system described in FIG. 4 is achieved by implementing the method for receiving data in the OFDM system described in FIG. 3 as an apparatus, and a duplicated description will be omitted.

### Detailed Embodiment

Hereinafter, a detailed exemplary embodiment will be described in detail with reference to the accompanying drawings. In the detailed exemplary embodiment, a hybrid fiber coax (HFC) cable network which is an OFDM based cable network is described as an example, but the detailed exemplary embodiment may be applied even in another transmission network (for example, a wireless network).

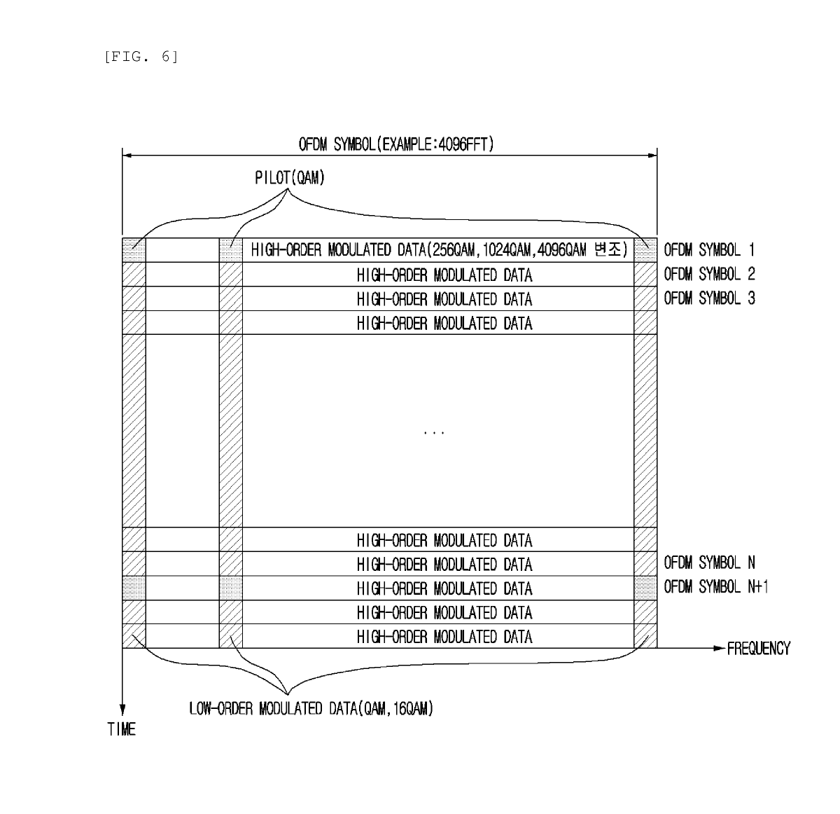

FIG. 5 is a diagram for describing a detailed exemplary embodiment of a configuration of a transmission system including a transmitting unit and a receiving unit.

First, a transmitting unit 510 will be described. An encoder 511 performs channel encoding for error correction, and a signal mapping unit 512 performs signal mapping (for example, mapping a bit signal to a 4096 QAM modulation signal). A frame configuration unit 513 positions the frame at a predetermined band for each service in a frequency area of the OFDM symbol or for each user in one service. A differentially modulated pilot is inserted for integer ratio frequency synchronization and 1-tap channel equalization. An output of the frame configuration unit 513 is subjected to IFFT by a block (OFDM symbol) unit so as for an inverse FFT (IFFT) unit 514 to transform a frequency area signal to a time area signal. A cyclic prefix (CP) inserting unit 515 inserts a CP larger than a channel delay time in order to remove inter-symbol interference (ISI) and inter-channel interference (ICI). That is, a part of an end of an IFFT output signal block is copied to be positioned at a front part of an IFFT output signal.

A digital-to-analog converter/radio frequency (DAC/RF) unit 516 converts a digital signal received from the CP inserting unit into an analog signal, and thereafter, converts and amplifies a base band signal into a radio frequency (RF) band signal and transmits the converted and amplified RF band signal.

Next, a receiving unit 520 will be described. The OFDM scheme receiving unit 520 converts the analog signal into the digital signal by converting the RF signal received by the RF/ADC unit 521 through a cable network into the base band signal. A time/minute frequency synchronizing unit 522 performs time and minute frequency offset synchronization by using the CP. A CP removing unit 523 removes the CP from a signal received from the time/frequency synchronizing unit. An FFT unit 524 converts the time area signal which is an output of the CP removing unit 523 into the frequency area signal and transfers the converted frequency area signal to an integer frequency and frame synchronizing unit 525. The integer frequency and frame synchronizing unit 525 acquires an integer frequency offset by using a differentially modulated pilot signal pattern to perform frame synchronization. A channel distortion estimating unit 526 estimates a channel distortion state of frequency selective fading by multi-wave interference by using the pilot signal and the low-order modulated data signal which have been already known. An equalization unit 527 performs 1-tap channel equalization by using channel distortion estimation information from the channel distortion estimating unit 526. A signal determining unit 528 determines an output signal of the equalization unit as one point of a constellation. A signal demapping unit 529 demaps the determined signal, and a decoder 530 decodes the demapped signal.

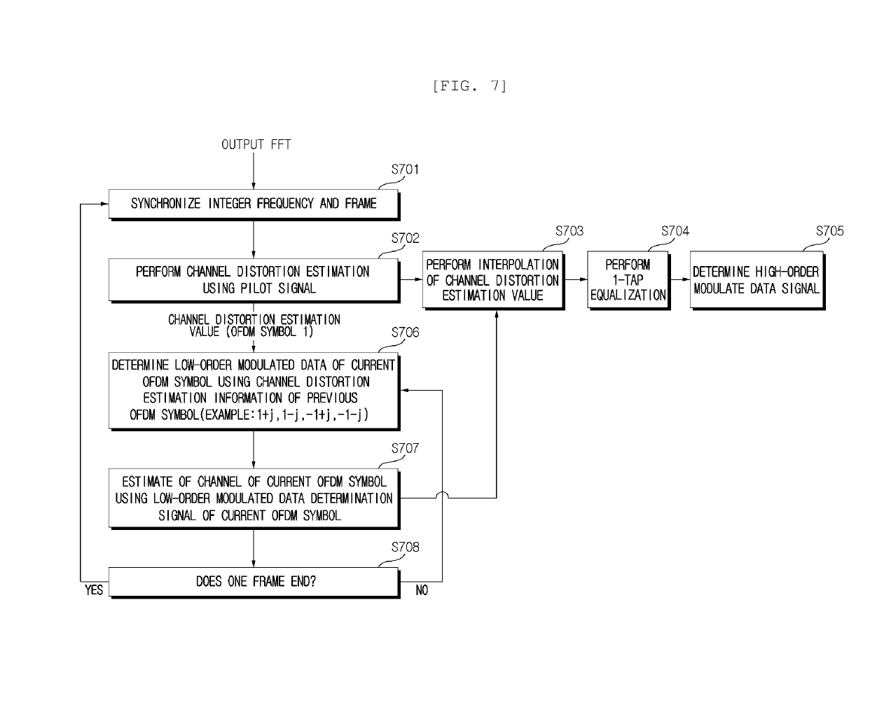

FIG. 6 is a diagram for describing an example of a signal frame generated in a frame configuration unit in the transmission system described in FIG. 5.

Referring to FIG. 6, a pilot symbol 601 is inserted into a first OFDM symbol in one frame constituted by N OFDM symbols for each predetermined cycle (for example, 6 cells) to keep a Nyquist sample rule. Not the known pilot symbol 601 but low-order modulated data 602 (a QAM or 16 QAM modulation signal, for example, in the case of QAM, 1+j, 1−j, −1+j, and −1−j) is inserted into the remaining N−1 OFDM symbols. This purpose is that the low-order modulated data 602 may be stably used for channel distortion estimation in the receiver. A position into which the low-order modulated data 602 is inserted may be inserted into a point at which the pilot 601 is positioned in the OFDM symbol, but may be placed at another position on a frequency cell. Herein, for convenience for the description, the low-order modulated data 602 is positioned in the same frequency array as the pilot symbol 601 as illustrated in FIG. 6.

FIG. 7 is a procedure diagram for describing a channel distortion estimation process described in the detailed exemplary embodiment of FIGS. 5 and 6 in detail. In the procedure diagram, the pilot symbol is included in the first OFDM symbol (OFDM symbol 1) of the frame, and the low-order modulated data symbol is included in each of the remaining OFDM symbols (OFDM symbols 2 to N).

Integer frequency synchronization and frame synchronization are performed with respect to an FFT output signal (S701). Channel distortion estimation is performed with respect to the first OFDM symbol of the frame including the pilot symbol by receiving the signal subjected to the integer frequency synchronization and frame synchronization (S702). In channel distortion estimation of the first OFDM symbol including the pilot symbol, a value of a subcarrier (frequency cell) at which the pilot symbols of the FFT output are positioned is divided by a pilot value which has been already known in the receiving unit to estimate a distortion state of a channel for a corresponding subcarrier.

Next, channel distortion estimation of the second OFDM symbol is performed. This is estimated by using the channel distortion estimation value estimated in the first OFDM symbol and the low-order modulated data included in the second OFDM symbol. First, the signal of the frequency cell including the low-order modulated data in the FFT output value of the second OFDM symbol is divided by the channel distortion estimation value of the corresponding frequency cell estimated in the first OFDM symbol to be equalized. A low-order modulated data signal is determined by using the equalized value (S706). An accurate channel distortion state of the second OFDM symbol which is a current symbol is estimated by using low-order modulated data determination signals (values of the QAM or 16 QAM constellation) acquired as above (S707). That is, the low-order modulated data determination signals are used like the pilot. Therefore, the channel distortion estimation is performed by dividing low-order modulated data signals among the FFT output values of the second OFDM symbol by the low-order modulated data determination signal of the corresponding frequency cell estimated in the second OFDM symbol in order to estimate the accurate channel distortion of the second OFDM symbol which is the current symbol. In regard to the estimated value, the channel distortion estimation of all FFT output cells is performed through channel distortion estimation value interpolation (S703). The FFT output value of the second OFDM symbol is divided by the channel distortion estimation value, that is, data are equalized through 1-tap equalization (S704) and signal determination for data of the second OFDM symbol is performed (S705).

Next, channel distortion estimation of a third OFDM symbol may be performed by using the channel distortion estimation value estimated in the second OFDM symbol and low-order modulated data of the third OFDM symbol (No in S708). First, a low-order modulated data signal in an FFT output value of the third OFDM symbol is divided by the channel distortion estimation value of the corresponding frequency cell estimated in the second OFDM symbol to be equalized. The low-order modulated data signal is determined by using the equalized value. An accurate channel distortion state of the third OFDM symbol which is a current symbol is estimated by using low-order modulated data determination signals (values of the QAM or 16 QAM constellation) acquired as above. Therefore, the channel distortion estimation is performed by dividing low-order modulated data signals among the FFT output values of the third OFDM symbol by the low-order modulated data determination signal of the corresponding frequency cell estimated in the third OFDM symbol in order to estimate the accurate channel distortion of the third OFDM symbol which is the current symbol. In regard to the estimated value, channel distortion estimation of all FFT output cells is performed through channel distortion estimation value interpolation. The FFT output value of the third OFDM symbol is divided by the channel distortion estimation value, that is, data of the third OFDM symbol is equalized through 1-tap equalization, and as a result, signal determination for data is performed (herein, a detailed description such as a normalization process will be omitted).

This process is continued up to OFDM symbol N until one frame ends (S708).

When one frame ends, channel distortion estimation using the pilot is performed in an OFDM symbol (OFDM symbol N+1 of FIG. 6) including a pilot of the next frame and thereafter, the aforementioned process is repeatedly performed (Yes in S708).

At present, in an HFC downward cable transmission system, since an optical fiber section has gradually been close to a subscriber, an SNR environment is improved, and as a result, a modulation level for each subcarrier of the OFDM symbol tends to adopt high-order modulation signals such as 1024 QAM and 4096 QAM. Therefore, since the low-order modulated data using the QAM signal (1+j, 1−j, −1+j, and −1−j) or 16 QAM has no error, the low-order modulated data may be determined. However, if necessary, the low-order modulated data may be used by performing simple coding such as a Reed-Muller (RM) code. Meanwhile, in a channel in which a lot of errors occur in determining the QAM signal, since it is difficult to use the 1024 QAM and 4096 QAM, a simple code may be used.

This method acquires the substantially same BER performance while placing the low-order modulated data in a pilot section to thereby improve the frequency use efficiency. In particular, an error occurs at all times in frequency offset estimation, and this error influences even orthogonality between the respective cells of the OFDM symbol, but according to the exemplary embodiment, a problem that a signal constellation rotates between adjacent OFDM symbols may be alleviated.

Not general data but user related information (for example, frequency band information including information transmitted to a designated user) is provided as the low-order modulated data, and as a result, a power saving effect of a terminal may be improved. In particular, in the case where not the general data but physical layer service configuration information is provided as the low-order modulated data, the power saving effect of the terminal is improved and the system delay is reduced without an additional preamble control signal like DVB-C2.

The low-order modulated signal may be selected by the QAM or the 16 QAM depending on a configuration state of the cable network, and in the case where a state of a network is not good, the pilot may be controlled to be transmitted instead of the low-order modulated signal.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for transmitting data in an OFDM system, comprising:
encoding and modulating data to be transmitted;
configuring the modulated data as a frame constituted by N (an integer larger than 0) OFDM symbols; and
transmitting the configured frame,
wherein the frame includes a first OFDM symbol including a pilot symbol and a second OFDM symbol including a lower-order modulated symbol than the modulated data.

2. The method of claim 1, wherein the low-order modulated symbol includes the pilot symbol.

3. The method of claim 1, wherein the low-order modulated symbol includes a data symbol.

4. The method of claim 3, wherein the data symbol includes user information or physical layer service configuration information.

5. The method of claim 1, wherein:
the first OFDM symbol is a first OFDM symbol constituting the frame, and
the second OFDM symbol is all of remaining OFDM symbols of the frame.

6. An apparatus for transmitting data in an OFDM system, comprising:
a modulation unit encoding and modulating data to be transmitted;
a frame configuration unit configuring the modulated data as a frame constituted by N (an integer larger than 0) OFDM symbols; and
a transmitting unit transmitting the configured frame,
wherein the frame includes a first OFDM symbol including a pilot symbol and a second OFDM symbol including a lower-order modulated symbol than the modulated data.

7. The apparatus of claim 5, wherein the low-order modulated symbol includes the pilot symbol.

8. The apparatus of claim 5, wherein the low-order modulated symbol includes a data symbol.

9. The apparatus of claim 8, wherein the data symbol includes user information or physical layer service configuration information.

10. The apparatus of claim 5, wherein:
the first OFDM symbol is a first OFDM symbol constituting the frame, and
the second OFDM symbol is all of remaining OFDM symbols of the frame.

11. A method for receiving data in an OFDM system, comprising:
receiving a frame including a first OFDM symbol including a pilot symbol and a second OFDM symbol including a lower-order modulated symbol than modulated data, in which the modulated data is constituted by N (an integer larger than 0) OFDM symbols;
a first estimation step of performing channel distortion estimation by using the first OFDM symbol including the pilot symbol in the frame; and
a second estimation step of performing channel distortion estimation by using an estimation value of the first estimation step and the second OFDM symbol including the lower-order modulated symbol than the modulated data.

12. The method of claim 11, wherein the low-order modulated symbol includes the pilot symbol.

13. The method of claim 11, wherein the low-order modulated symbol includes a data symbol.

14. The method of claim 13, wherein the data symbol includes user information or physical layer service configuration information.

15. The method of claim 11, wherein:
the frame is constituted by the first OFDM symbol of the frame including the pilot symbol and the remaining N−1 OFDM symbols including the respective low-order modulated symbols, and
the second estimation step further includes
a consecutive estimation step of performing channel distortion estimation by using a channel distortion estimation value using an n-th OFDM symbol (an integer of 1<n<N)and the low-order modulated symbol included in the n+1-th OFDM symbol; and
a repetition process of repeating the consecutive estimation step up to an N-th OFDM symbol.

16. An apparatus for receiving data in an OFDM system, comprising:
a receiving unit receiving a frame including a first OFDM symbol including a pilot symbol and a second OFDM symbol including a lower-order modulated symbol than modulated data, in which the modulated data is constituted by N (an integer larger than 0) OFDM symbols; and
a channel distortion estimating unit performing first channel distortion estimation by using the first OFDM symbol including the pilot symbol in the frame, and performing second channel distortion estimation by using an estimation value of the first channel distortion estimation and the second OFDM symbol including the lower-order modulated symbol than the modulated data.

17. The apparatus of claim 16, wherein the low-order modulated symbol includes the pilot symbol.

18. The apparatus of claim 16, wherein the low-order modulated symbol includes a data symbol.

19. The apparatus of claim 18, wherein the data symbol includes user information or physical layer service configuration information.

20. The apparatus of claim 16, wherein:
the frame is constituted by the first OFDM symbol of the frame including the pilot symbol and the remaining (N−1) OFDM symbols including the respective low-order modulated symbols, and
the channel distortion estimating unit
performs channel distortion estimation for the second OFDM symbol by using the estimation value of the channel distortion estimation for the first OFDM symbol and the low-order modulated symbol included in the second OFDM symbol of the frame, and
performs channel distortion estimation for an n+1-th OFDM symbol by using a channel distortion estimation value using an n-th OFDM symbol (an integer of 1<n<N) and the low-order modulated symbol included in the n+1-th OFDM symbol to repeat channel distortion estimation up to an N-th OFDM symbol.
